(19) United States
(12) Patent Application Publication
(10) Pub. No.: US 2005/0206818 A1
(43) Pub. Date: Sep. 22, 2005

(54) Optical element, process for production thereof, substrate for liquid crystal alignment, liquid crystal display device, and birefringent material

(75) Inventor: Shinji Hayashi, Shinjuku-Ku (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 11/047,356

(22) Filed: Jan. 31, 2005

(30) Foreign Application Priority Data
Feb. 2, 2004 (JP) 2004-025676

(51) Int. Cl. G02F 1/1337

(52) U.S. Cl. 349/123

(57) ABSTRACT

There is provided an optical element which has desired birefringence characteristics and, at the same time, has a low haze value. The optical element comprises: a birefringence layer comprising a chiral agent and a polymerizable liquid crystal comprised of rodlike molecules; and a light transparent base material for supporting the birefringence layer. The polymerizable liquid crystal has a molecular arrangement which has been fixed by crosslinking while holding a planar cholesteric phase structure. A substrate layer underlying the birefringence layer is formed of glass or silicon oxide.

### BACKGROUND OF THE INVENTION

1. Field of the Invention

The present invention relates to an optical element comprising a birefringence layer and a process for production thereof, a substrate for liquid crystal alignment having a birefringence layer, and a liquid crystal display device comprising the substrate for liquid crystal alignment. The present invention also relates to a birefringent material.

2. Background Art

Liquid crystal display devices have advantages including that a reduction in thickness and a reduction in weight can be easily realized, the power consumption is low, and the occurrence of flicker can easily be prevented. By virtue of these advantages, liquid crystal display devices have drawn attention as flat panel displays, and the market of liquid crystal display devices for use as display devices of personal computers or television receivers has been rapidly expanded. Further, an increase in size of the liquid crystal display device is also being forwarded.

For these liquid crystal display devices, various display modes have been developed. Since liquid crystals have birefringent properties, any display mode of liquid crystal display devices basically has visual angle dependency. In large-size liquid crystal display devices, the practical visual angle is larger than that in small-size liquid crystal display devices. Therefore, an increase in size of liquid crystal display devices leads to an increasing demand for an improvement in visual angle dependency. To meet this demand, not only the development of liquid crystal display devices but also the development of various optical elements, which optically compensate light incident on the liquid crystal cell or light which exits from the liquid crystal cell to increase the viewing angle, has been made.

Liquid crystal cells for optical compensation or optical compensation films comprising an optically monoaxially or biaxially stretched resin film have hitherto been used as the optical element. This optical compensation film has been applied to a liquid crystal cell with the aid of a pressure-sensitive adhesive.

In the above construction, the refractive index of the pressure-sensitive adhesive is generally smaller than the refractive index of the underlying substrate layer. Therefore, reflection takes place at the interface between pressure-sensitive adhesive and underlying substrate, and, thus, the contrast of the display image is likely to be lowered. Further, moisture absorption causes a change in volume which in turn causes a change in birefringence characteristics. Therefore, when this optical element is applied to a large liquid crystal display device, a change in birefringence characteristics derived from the volume change is significant, and distortion of display images is likely to take place. For the above reason, in recent years, the development of an optical element, which requires the use of no pressure-sensitive adhesive and has stable birefringence characteristics, has been forwarded utilizing liquid crystal materials.

For example, Japanese Patent Laid-Open No. 29037/2003 discloses a retardation film comprising a cholesterically aligned liquid crystal material provided on a polymeric film that has not been subjected to alignment treatment and has a retardation under 50 nm. Specifically, the above patent document describes a method for preparing a retardation film (an optical compensation film). This method comprises coating a solution containing a thermotropic liquid crystal compound, which exhibits a cholesteric liquid crystal phase in a liquid crystal state, onto a polymeric film, which has not been subjected to aligning treatment such as surface rubbing treatment, aligning layer formation or the like and has not been subjected to stretching alignment treatment etc., subjecting the coating to aligning treatment, and then curing the treated coating.

Japanese Patent Laid-Open No. 185827/2003 discloses a process for producing a selective reflecting member and a color selecting member, although optical compensation is not intended. This process comprises coating a liquid crystal composition containing a polymerizable liquid crystal compound, a chiral agent, and an air interface aligning agent onto a substrate not subjected to uniaxial alignment treatment and then polymerizing the liquid crystal composition. In the patent document, in paragraph [0007], there is a description reading: “The alignment of the helical axis in the cholesteric liquid crystal phase is not uniform.” Further, in paragraph [0008], there is a description reading: “has a uniform light scattering state.” Therefore, it is considered that the layer, described in the patent document, formed by polymerizing the liquid crystal composition is not a planar cholesteric liquid crystal layer that functions as a birefringence layer.

In the production process of an optical film described in Japanese Patent Laid-Open No. 29037/2003, however, it is difficult to align, in an orderly manner, the thermotropic liquid crystal compound on a surface of a polymeric film to provide a planar cholesteric phase state. Further, the optical film produced by this process is disadvantageous in that the haze attributable to the disturbance of the alignment of the liquid crystal compound is relatively large.

Further, in order to form a birefringence layer utilizing a cholesteric liquid crystal, the molecular arrangement should be fixed while holding a cholesteric phase structure in which the helical axis of the molecular arrangement is uniformly parallel to the surface of the substrate (focal conic state) or is uniformly perpendicular to the surface of the substrate (planar state). For example, the formation of the cholesteric liquid crystal layer on an aligning film prepared by a rubbing method permits the molecular arrangement of the cholesteric liquid crystal layer to be brought to a planar state. When an aligning film is prepared by the rubbing method, however, a relatively troublesome step is necessary for reducing the influence of static electricity or dust produced by rubbing.

Further, the molecular arrangement of this cholesteric liquid crystal layer may also be brought to a planar state by forming the cholesteric liquid crystal layer on a uniaxially stretched resin film. Since, however, the uniaxially stretched resin film per se has birefringence characteristics, in order to provide an optical element having desired birefringence characteristics, the formed cholesteric liquid crystal layer should be transferred onto other optically isotropic member.

### SUMMARY OF THE INVENTION

The present invention has been made with a view to solving the above problems of the prior art, and an object of the present invention is to provide an optical element that has desired birefringence characteristics and, at the same time, has a small haze value. Another object of the present invention is to provide a production process which can produce this optical element in an efficient and cost-effective manner. A further object of the present invention is to provide a substrate for liquid crystal alignment and liquid crystal display device using this optical element.

The present inventors have now found that, when a coating composition comprising a chiral agent and a polymerizable liquid crystal comprised of rodlike molecules is coated directly onto glass or silicon oxide layer to form a coating which is then heated, the liquid crystal molecules of the polymerizable liquid crystal in the coating can be aligned while holding the planar cholesteric phase structure. The present invention has been made based on such findings.

According to one aspect of the present invention, there is provided an optical element comprising: a birefringence layer comprising a chiral agent and a polymerizable liquid crystal comprised of rodlike molecules; and a light transparent base material for supporting the birefringence layer,

said polymerizable liquid crystal having a molecular arrangement which has been fixed by crosslinking while holding a planar cholesteric phase structure,

a substrate layer underlying said birefringence layer being formed of glass or silicon oxide.

According to another aspect of the present invention, there is provided a process for producing an optical element, said process comprising:

providing a light transparent base material provided with a film formed of glass or silicon oxide;

coating a coating composition comprising a chiral agent and a polymerizable liquid crystal of rodlike molecules onto a said film formed of glass or silicon oxide,

aligning said polymerizable liquid crystal in the coating to a planar cholesteric phase; and

crosslinking said polymerizable liquid crystal in such a state that the alignment in the planar cholesteric phase is held, thereby fixing the molecular arrangement of said polymerizable liquid crystal.

According to still another aspect of the present invention, there is provided a substrate for liquid crystal alignment, comprising at least a light transparent base material and an aligning film provided on one side of said light transparent base material, wherein

a birefringence layer is provided between said light transparent base material and said aligning film or on the base material in its surface remote from said aligning film, said birefringence layer comprises a chiral agent and a polymerizable liquid crystal comprised of rodlike molecules, and the molecular arrangement of the polymerizable liquid crystal has been fixed by crosslinking while holding a planar cholesteric phase structure, and

a substrate layer underlying said birefringence layer is formed of glass or silicon oxide.

According to a further aspect of the present invention, there is provided a liquid crystal display device comprising a liquid crystal panel for display, said liquid crystal panel comprising: a first substrate for liquid crystal alignment located on its display surface side; and a second substrate for liquid crystal alignment located on its backside, wherein

said first substrate for liquid crystal alignment and/or said second substrate for liquid crystal alignment are said substrate for liquid crystal alignment.

According to another aspect of the present invention, there is provided a birefringent material comprising a chiral agent, a polymerizable liquid crystal comprised of rodlike molecules, and a silane coupling agent, wherein the molecular arrangement of said polymerizable liquid crystal has been fixed by crosslinking while holding a planar cholesteric phase structure.

The birefringence layer constituting the optical element according to the present invention may be formed by a relatively simple process, that is, a process comprising coating of a coating composition, alignment treatment, and crosslinking treatment. Therefore, the optical element can be efficiently produced, and, thus, an inexpensive optical element can be realized. Further, even when the thickness of the birefringence layer is increased, the polymerizable liquid crystal can easily be aligned in a planar cholesteric phase. Therefore, according to the present invention, an optical element having desired birefringence characteristics and a small haze value can be realized.

Further, in the substrate for liquid crystal alignment according to the present invention, the birefringence layer may be utilized as a layer for controlling the state of polarization of light, such as an optical compensation layer or a phase difference layer. Therefore, a liquid crystal display device having excellent display characteristics can be produced in an efficient manner.

Furthermore, in the substrate for liquid crystal alignment according to the present invention, the molecular arrangement of the polymerizable liquid crystal constituting the birefringence layer has been fixed by crosslinking, and, hence, a change in volume derived from moisture absorption of the birefringence layer does not substantially take place. Therefore, during or after a production process of a substrate for liquid crystal alignment, birefringence characteristics of the optical element are less likely to be changed. Therefore, a substrate for liquid crystal alignment having excellent productivity and display characteristics can be realized.

Further, the liquid crystal display device according to the present invention can be produced at a low cost, because a substrate for liquid crystal alignment having excellent productivity and display characteristics is used.

Furthermore, according to the birefringent material of the present invention, since a birefringence layer having desired birefringence characteristics and a small haze value can be prepared at a low cost, a specific optical element used for controlling the state of polarization of light in various fields, that is, an optical element, which is optically uniaxial and has an optical axis in the thickness-wise direction of the element, can be produced at a low cost.

### BRIEF DESCRIPTION OF THE DRAWINGS

FIG. 1 is a schematic diagram showing one embodiment of the basic sectional structure of the optical element according to the present invention;

FIG. 2 is a typical cross-sectional view of the structure of the birefringence layer shown in FIG. 1;

FIG. 3 is a schematic diagram showing another embodiment of the basic sectional structure of the optical element according to the present invention;

FIGS. 4 (a) to (c) are a schematic diagram showing still another embodiment of the basic sectional structure of the optical element according to the present invention;

FIG. 5 is a schematic diagram showing a further embodiment of the basic sectional structure of the optical element according to the present invention;

FIG. 6 is a schematic diagram showing one embodiment of the basic sectional structure of the substrate for liquid crystal alignment according to the present invention; and

FIG. 7 is a schematic partially sectional view showing one embodiment of the liquid crystal display device according to the present invention.

### DETAILED DESCRIPTION OF THE INVENTION

Embodiments of each of the optical element, process for production thereof, substrate for liquid crystal alignment, liquid crystal display device, and birefringent material according to the present invention will be described in detail, if necessary, with reference to the accompanying drawings.

<Optical Element and Birefringent Material in First Embodiment of Invention>

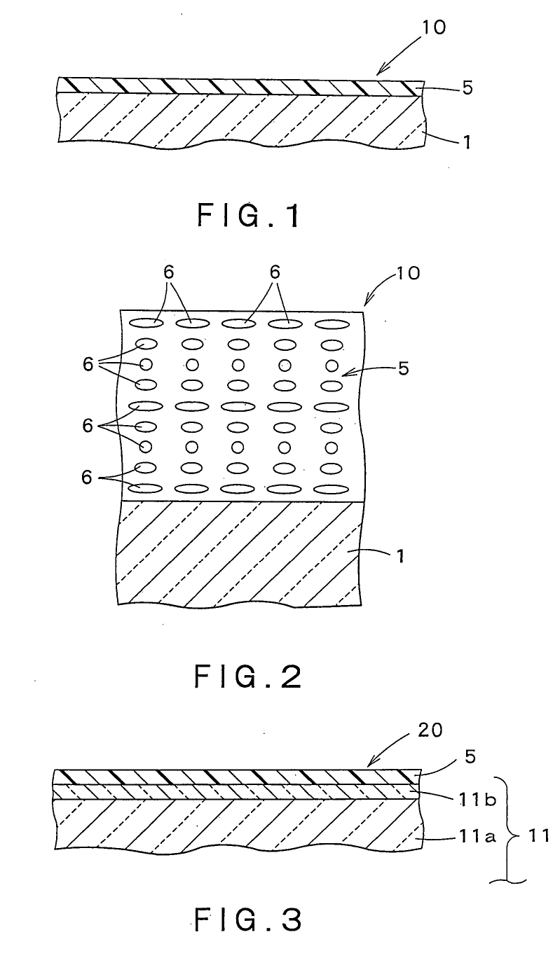

FIG. 1 is a schematic diagram showing an embodiment of the basic sectional structure of the optical element according to the present invention. An optical element 10 includes a light transparent base material 1 of glass (hereinafter referred to as “glass substrate 1”) and a birefringence layer 5 provided directly on one side of the glass substrate 1. The birefringence layer 5 is supported by the glass substrate 1. The term “glass substrate” as used herein refers to a plate base material formed of glass, as well as a sheet base material formed of glass.

The glass substrate may be formed of either a single-component glass or a multicomponent glass. When the optical element 10 is utilized, for example, as a part of a substrate for liquid crystal alignment, the glass substrate 1 is preferably an alkali-free glass. If necessary, a light shielding region or the like may be locally provided on the glass substrate 1. The light transmittance of the glass substrate 1 may be properly selected according to the applications of the optical element 10 and the like.

The birefringence layer 5 provided on the glass substrate 1 contains a chiral agent and a polymerizable liquid crystal comprised of rodlike molecules and a structure that the molecular arrangement of the polymerizable liquid crystal has been fixed by crosslinking.

FIG. 2 is a typical cross-sectional view showing the structure of the birefringence layer 5. As shown in the drawing, the birefringence layer 5 comprises rodlike polymerizable liquid crystal molecules 6 as structural units. The arrangement of the polymerizable liquid crystal molecules 6 has been fixed by crosslinking while holding the planar cholesteric phase structure. In FIG. 2, for convenience, a bonding group in the polymerizable liquid crystal molecules 6 is not shown. Further, the chiral agent is also not shown.

The tilt angle of the polymerizable liquid crystal molecules 6 as the structural unit in the birefringence layer 5 is preferably substantially even in the thickness-wise direction of the birefringence layer 5. The “tilt angle of the polymerizable liquid crystal molecules as the structural unit is substantially even in the thickness-wise direction of the birefringence layer” as used herein means that the optical axis of the birefringence layer 5 is substantially parallel to the thickness-wise direction and the haze value of the birefringence layer 5 is not more than 1%.

Chiral agents usable for constituting the birefringence layer 5 include compounds having any chirality in the molecule thereof, for example, (i) compounds having one or at least two asymmetric carbons, (ii) compounds having asymmetric points on a hetero atom such as chiral amines or chiral sulfoxides, or (iii) compounds having an optically active site with axial asymmetry such as cumulene or binaphthol. The molecular weight of the chiral agent is preferably not more than about 1500. The chiral agent may be polymerizable or not polymerizable. However, the polymerizable chiral agent is preferred. Specific examples of polymerizable chiral agents include, for example, chiral agents represented by formula (i): 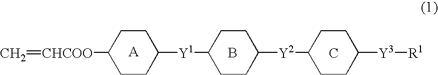
wherein n is 0 or 1, R¹ represents any one of the following groups: 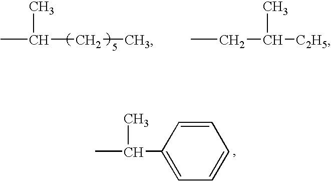
Y¹ and Y² each independently represent a group represented by —CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH═CHCH₂CH₂—, or —CH₂CH₂CH═CH—, Y³ represents an oxygen atom or a group represented by —COO—, —OCO—, or —OCOO—, six-membered rings represented by A, B, and C each independently represent any one of the following groups: 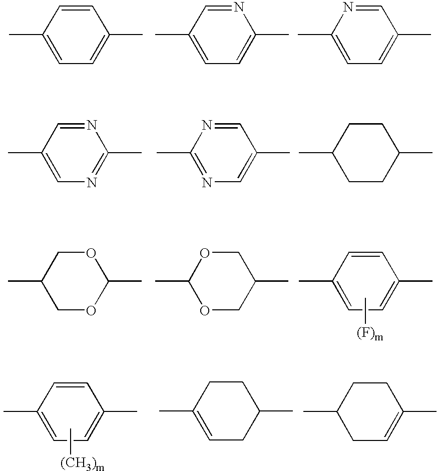
provided that, in each formula, m is an integer of 1 to 4, chiral agents represented by formula (i) or (ii): 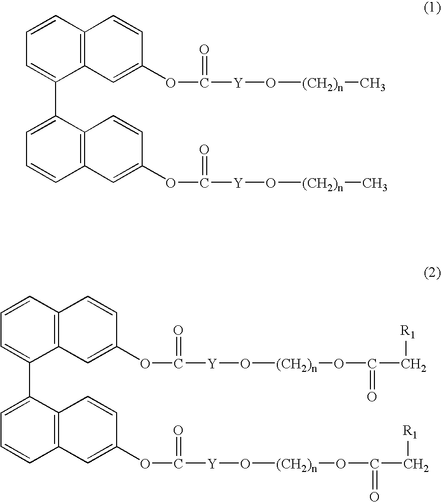
wherein n is an integer of 2 to 12, R₁ represents a methyl group, an ethyl group, or a hydrogen atom, and Y represents any one of the following groups: 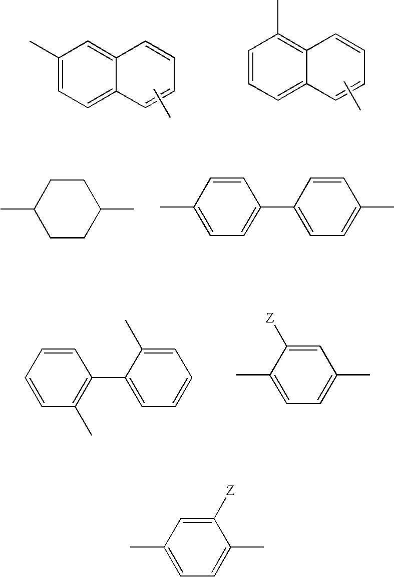
where Z represents a hydrogen atom, a chlorine atom, a bromine atom, a methoxy group, a cyano group, a nitroso group, or a group represented by —(CH₂)ₘCH₃, provided that m is an integer of 1 to 4, and chiral agents represented by formula (i) or (ii): 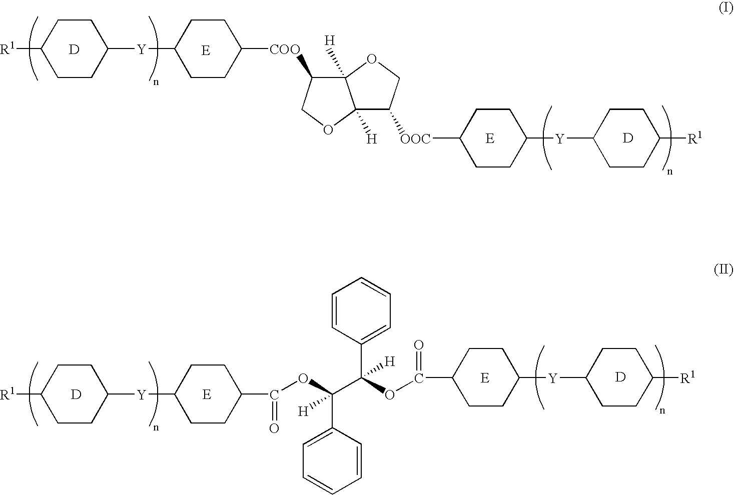
wherein n is 0 (zero) or 1, R¹ represents —(CH₂)ₘCH₃, —O(CH₂)ₘCH₃, —OOC(CH₂)ₘCH₃, or —OOCO(CH₂)_{q}OOCH═CH₂, wherein m is an integer of 0 to 12, q is an integer of 1 to 6, Y represents a group represented by —CH₂CH₂—, —COO—, or —OCO—, and six-membered rings represented by D and E each independently represent any one of the following groups: 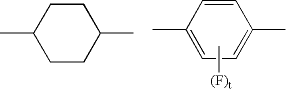
wherein t is an integer of 0 to 4.

Either one chiral agent or two or more chiral agents may be used as the chrial agent contained in the birefringence layer 5. The total content of the chiral agents may be properly selected depending upon the design value of the selective reflection center wavelength of the birefringence layer 5. The center wavelength can be set in a visible region. However, for example, when the optical element 10 is used as an element for controlling the polarization state of visible light, preferably, the center wavelength is set in an ultraviolet region. When the selective reflection center wavelength of the birefringence layer 5 is set in the ultraviolet region, the content of the chiral agent in the birefringence layer 5 may be properly selected in the range of about 1 to 20% by weight, although the chiral agent content depends upon the refractive index no, ne of the polymerizable liquid crystal.

On the other hand, the polymerizable liquid crystal constituting the birefringence layer 5 is preferably such that each molecule contains two or more functional groups (this polymerizable liquid crystal being hereinafter referred to as “polyfunctional polymerizable liquid crystal”). The polymerizable liquid crystal may be a mixture of the polyfunctional polymerizable liquid crystal with a polymerizable liquid crystal in which each molecule contains only one functional group (this polymerizable liquid crystal being hereinafter referred to as “monofunctional polymerizable liquid crystal”). The birefringence Δn of the polymerizable liquid crystal molecules is preferably about 0.03 to 0.20, more preferably about 0.05 to 0.15. Specific examples of the polyfunctional polymerizable liquid crystal satisfying the above requirement include polymerizable liquid crystals represented by formulae (I) to (III): 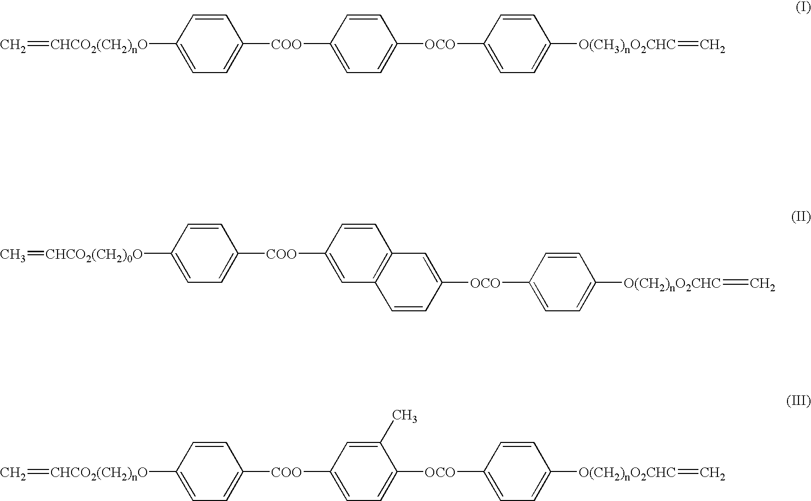
wherein n is an integer of 3 to 6.

Specific examples of monofunctional polymerizable liquid crystals include polymerizable liquid crystals represented by formulae (i) to (iv): 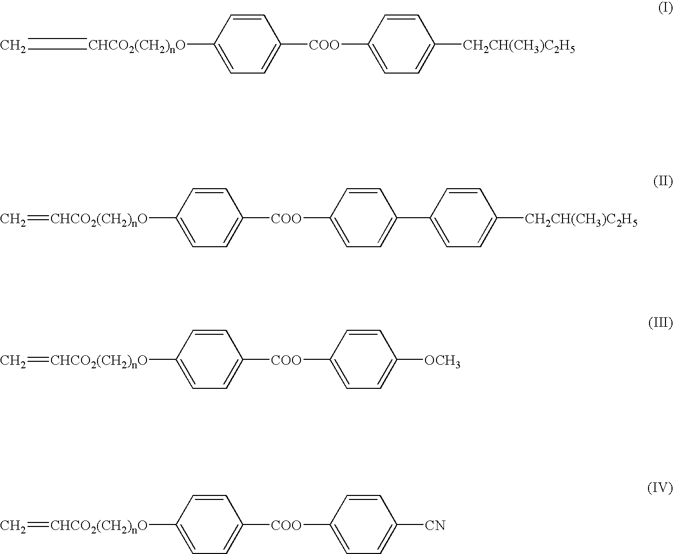
wherein n is an integer of 3 to 6.

When the polyfunctional polymerizable liquid crystal and the monofunctional polymerizable liquid crystal are used in combination, the amount of the monofunctional polymerizable liquid crystal used is preferably not more than about 10% by weight, more preferably not more than about 5% by weight, based on the total amount of the polymerizable liquid crystal. The combined use of the polyfunctional polymerizable liquid crystal and the monofunctional polymerizale liquid crystal can improve or disimprove the alignment of the whole polymerizable liquid crystal. Therefore, the alignment of the whole polymerizable liquid crystal can be easily controlled.

Either only one polyfunctional polymerizable liquid crystal or two or more polyfunctional polymerizable liquid crystals may be used for constituting the birefringence layer 5. Likewise, when the polyfunctional polymerizable liquid crystal and the monofunctional polymerizable liquid crystal are used in combination, either only one monofunctional polymerizable liquid crystal or two or more monofunctional polymerizable liquid crystals may be used in this combination.

In the birefringence layer 5, since the molecular arrangement of the polymerizable liquid crystal has been fixed by crosslinking while holding a planar cholesteric phase structure, when xyz orthogonal coordinate is assumed with the thickness-wise direction of the birefringence layer 5 being z axis, the refractive index nx in x axis direction is substantially equal to the refractive index ny in y axis direction, and the refractive index in z axis direction is smaller than the refractive indexes nx, ny. Specifically, the birefringence layer 5 is a uniaxial birefringence layer in which the thickness-wise direction (z axis direction) is an optical axis. The birefringence layer 5 functions as the so-called “—C plate.”

Retardation occurs in light incident on the birefringence layer 5 at an incident angle of more than 0 degree. The retardation is an optical path difference between ordinary light and extraordinary light in the birefringence layer 5. Therefore, the retardation of the optical element can be controlled by properly selecting the thickness of the birefringence layer 5, the birefringence Δn (difference between refractive index no of ordinary light and refractive index ne of extraordinary light) of the polymerizable liquid crystal molecules 6, and the orientational order of the polymerizable liquid crystal molecules.

The above birefringence layer 5 may be formed by coating a coating composition containing at least the above chiral agent and the polymerizable liquid crystal to form a coating, aligning the liquid crystal molecules so that the polymerizable liquid crystal in the coating is brought to a planar cholesteric phase structure, and then, in this state, three-dimensionally crosslinking at least the polymerizable liquid crystal. If necessary, the coating composition may contain a silane coupling agent, a photopolymerization initiator, a sensitizer, a polyfunctional monomer and the like.

The incorporation of the silane coupling agent can facilitate the alignment of the polymerizable liquid crystal molecules in a planar cholesteric phase in a more orderly manner. As a result, the haze value in the optical element can be reduced. Further, even when the thickness of the birefringence layer is increased, the polymerizable liquid crystal molecules can easily be aligned in a planar cholesteric phase. Therefore, the degree of freedom in the thickness of the birefringence layer can be enhanced. This in turn can realize the control of retardation of the optical element on various levels. Further, the incorporation of the polyfunctional monomer can improve the crosslinkability of the birefringence layer 5.

In the formation of the birefringence layer, preferably, the silane coupling agent can horizontally align the polymerizable liquid crystal molecules at the interface on the glass substrate side. Such silane coupling agents suitably usable herein include, for example, those having a hydrophilic functional group such as amines. The silane coupling agent is preferably soluble in organic solvents, because the silane coupling agent is added to the polymerizable liquid crystal. Further, in order to align the polymerizable liquid crystal molecules in a planar cholesteric phase, the polymerizable liquid crystal should be once heated to a liquid crystal phase (nematic phase) state. Therefore, the silane coupling agent should have heat resistance on such a level that does not cause decomposition upon the heating.

Specific examples of such silane coupling agents include: KBM-602, KBM-603, and KBM-903 all of which are manufactured by The Shin-Etsu Silicone Co., Ltd.; TSL 8331, TSL 8340, and TSL 8345 all of which are manufactured by Toshiba Silicone Co., Ltd.; and SH 6020 and SH 6023 all of which are manufactured by Dow Corning.

When the silane coupling agent is incorporated in the birefringence layer, only one silane coupling agent may be used, or alternatively a plurality of, that is, two or more, silane coupling agents may be used. The content of the silane coupling agent varies depending upon the thickness of the birefringence layer, the type of the silane coupling agent used and the like. Preferably, however, the content of the silane coupling agent is in the range of about 0.01 to 1% by weight, more preferably in the range of about 0.05 to 0.5% by weight, based on the total amount of the polymerizable liquid crystal. When the content of the silane coupling agent is above the upper limit of the above-defined content range, in a birefringence layer formation process, the alignment of the whole polymerizable liquid crystal in a planar cholesteric phase becomes difficult.

The degree of crosslinking of the birefringence layer is preferably not less than about 80%, more preferably not less than about 90%. The thickness of the birefringence layer is not particularly limited and may be properly selected in such a thickness range that provides a target retardation level, so far as the polymerizable liquid crystal molecules can be aligned in a planar cholesteric phase, that is, the thickness is not less than the helical pitch of the cholesteric phase.

In the optical element according to the present invention, the birefringence layer can be formed in a simple procedure, that is, by successively carrying out coating of a coating composition, alignment treatment, and crosslinking treatment. Therefore, the optical element according to the present invention can be produced with high productivity. Further, since the birefringence layer 5 is provided directly on a glass substrate, continuous production is possible and, at the same time, the haze value can be reduced. The incorporation of the silane coupling agent in the birefringence layer can further reduce the haze value.

The optical element according to the present invention can be used as an element for controlling the state of light polarization, for example, retardation elements and optical compensation elements. Further, since the birefringence layer has excellent heat resistance, the optical element according to the present invention can also be applied to optical equipment used under an environment where a rise in temperature is relatively likely to take place, for example, in the interior of cars. Furthermore, since the birefringence layer has excellent heat resistance, a liquid crystal panel for display can be constructed so that the birefringence layer is disposed on the liquid crystal layer side.

The birefringent material according to the present invention comprises a chiral agent, a polymerizable liquid crystal having a rodlike molecular shape, and a silane coupling agent, and the molecular arrangement of the polymerizable liquid crystal has been fixed by crosslinking while holding the planar cholesteric phase structure. The birefringence layer containing the silane coupling agent corresponds to a layer formed of the birefringent material according to the present invention.

The birefringent material according to the present invention can be prepared by the above method for birefringence layer formation. The birefringence layer using the birefringent material can be provided directly on the surface of the substrate formed of glass or silicon oxide. The form of the substrate on which the birefringence layer is provided may be properly selected from plates, sheets, films and the like. The layer construction of the substrate may be properly selected. The glass then film can be formed, for example, by sol-gel process or chemical vapor deposition (CVD). On the other hand, the silicon oxide film may be formed, for example, by physical vapor deposition (PVD) or chemical vapor deposition (CVD).

<Optical Element in Second Embodiment of Invention>

FIG. 3 is a schematic diagram showing another embodiment of the basic sectional structure of the optical element according to the present invention. The construction of an optical element 20 is the same as the construction of the optical element 10 in the first embodiment of the present invention, except that, in the optical element 20, a light transparent resin substrate 11a and a silicon oxide film 11b formed directly on one side of the resin substrate 11a constitute a light transparent base material 11. Accordingly, the birefringence layer is identified with the same reference number as used in FIGS. 1 and 2, that is, “5,” and the explanation thereof will be omitted. The expression “light transparent resin substrate” as used herein refers to a plate, a sheet, or a film formed of a light transparent resin.

The resin substrate 11a may be any resin substrate so far as it has a desired light transmittance. From the viewpoint of providing an optical element having desired birefringence characteristics, however, the resin substrate 11a is preferably optically isotropic or has small optical anisotropy. The material for the resin substrate 11a may be properly selected according to applications of the optical element and the like.

As described above, the silicon oxide film 11b may be formed by physical vapor deposition (PVD) or chemical vapor deposition (CVD), and the thickness of the silicon oxide film 11b may be properly selected. The thickness of the silicon oxide film 11b is preferably small from the viewpoint of providing a highly flexible optical element.

The optical element having the above structure has the same technical effect as the optical element in the first embodiment. Further, since the resin substrate 11a and the silicon oxide film 11b constitute the light transparent base material 11, the flexibility of the optical element can be improved. A glass thin film can be used instead of the silicon oxide film 11b.

<Optical Element in Third Embodiment of Invention>

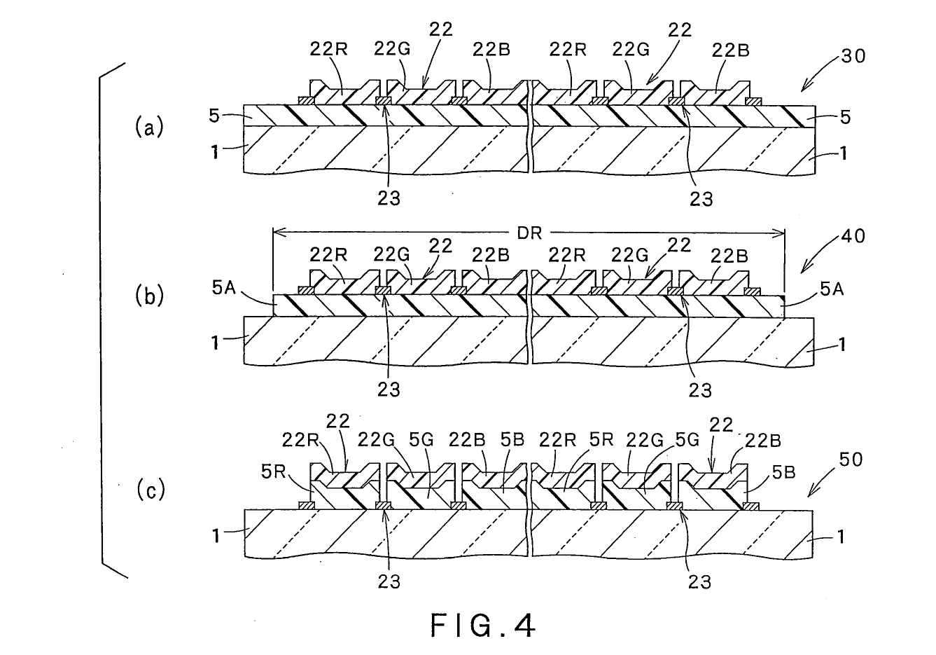

FIG. 4 (a) is a schematic diagram showing still another embodiment of the basic sectional structure of the optical element according to the present invention. In an optical element 30, a birefringence layer 5 is formed on a glass substrate 1. A light absorption-type color filter 22 (hereinafter referred to simply as “color filter 22”) and a light shielding layer (a black matrix) 23 are provided on the birefringence layer 5. That is, the structure of the optical element 30 is the same as the optical element 10 in the first embodiment shown in FIGS. 1 and 2, except that the color filter 22 and the light shielding layer (black matrix) 23 are formed on the birefringence layer 5. The optical element 30 may be used, for example, as a member for constituting the substrate for liquid crystal alignment.

In the constituent members shown in FIG. 4 (a), those common to FIG. 4(a) and FIG. 1 or 2 are identified with the same reference numerals, and the explanation thereof will be omitted.

Both the color filter 22 and the light shielding layer 23 are useful in the case where the optical element 30 is used, for example, as a constituent member of the substrate for liquid crystal alignment. The color filter 22 is a primary color filter in which a red micro-color filter 22R, a green micro-color filter 22G, and a blue micro-color filter 22B are arranged in a predetermined pattern. Various types of color filters called stripe, mosaic, triangle or other color filters depending upon the form of arrangement of the red micro-color filter 22R, the green micro-color filter 22G, and the blue micro-color filter 22B are known. A complementary color filter may be used instead of the primary color filter.

After the formation of the light shielding layer 23 which will be explained later, the color filter 22 may be formed, for example, by patterning a coating of a color resin as the material, for each of the red micro-color filter 22R, the green micro-color filter 22G, and the blue micro-color filter 22B, for example, by photolithography in a predetermined form, or by coating, for each of the red micro-color filter 22R, the green micro-color filter 22G, and the blue micro-color filter 22B, an ink for the color filter as the material in a predetermined form.

The light shielding layer 23 is provided, for example, for preventing leakage of light (light leakage) from between pixels in a liquid crystal panel for display, and for preventing light deterioration of an active element in an active matrix drive-type liquid crystal panel for display, and define, on plane vision, individual pixels in the liquid crystal panel for display. The red micro-color filter 22R, the green micro-color filter 22G, and the blue micro-color filter 22B are arranged, on plane vision, so as to cover predetermined pixels defined by the light shielding film 23.

The light shielding layer 23 may be formed by patterning a metallic thin film having light shielding or light absorbing properties, such as a metallic chromium thin film or a tungsten thin film, in a predetermined form. Alternatively, the light shielding layer 23 may be formed by printing an organic material such as a black resin in a predetermined form. A monochromatic color filter may also be used as the color filter 22. In this case, the provision of the light shielding layer 23 can be omitted.

The birefringence layer 5 has a size and a shape which overlap with the glass substrate 1 on plane vision. Therefore, the birefringence layer 5 is larger than the display region in the liquid crystal panel for display.

The optical element having the above construction has a birefringence layer and thus has the same technical effect as the optical element in the first embodiment. The substrate for liquid crystal alignment which utilizes the optical element 30 as a constituent member will be described in detail later.

An optical element having the same technical effect as the optical element 30 can also be produced by using, instead of the glass substrate 1, a light transparent base material comprising a glass thin film or a silicon oxide film formed directly on one side of a light transparent resin substrate, such as the light transparent base material 11 shown in FIG. 6. In the optical element in the third embodiment, the birefringence layer 5 is provided directly on the glass thin film or silicon oxide film.

<Optical Element in Fourth Embodiment of Present Invention>

FIG. 4 (b) is a schematic diagram showing a further embodiment of the basic sectional structure of the optical element according to the present invention. The construction of an optical element 40 is the same as the optical element in the third embodiment, except that the birefringence layer is provided only in a region DR corresponding to a display region in the liquid crystal panel for display (see FIG. 4 (a)). Accordingly, only the birefringence layer is identified with a new reference character “5A,” and the constituent members other than the birefringence layer 5A are identified with the same reference characters as used in FIG. 4 (a), and the explanation thereof will be omitted. The optical element in the fourth embodiment may be used, for example, as a constituent member in a substrate for liquid crystal alignment.

The optical element 40 has the same technical effect as the optical element 30 in the fourth embodiment. An optical element having the same technical effect as the optical element 40 in the fourth embodiment may also be produced by using, instead of the glass substrate 1, a light transparent base material comprising a glass thin film or a silicon oxide film provided directly on one side of a light transparent resin substrate. In this optical element, the birefringence layer 5A is provided directly on the glass thin film or silicon oxide film.

<Optical Element in Fifth Embodiment of Present Invention>

FIG. 4 (c) is a schematic diagram showing another embodiment of the basic sectional structure of the optical element according to the present invention. An optical element 50 is different from the optical element in the third embodiment in that birefringence layers 5R, 5G, and 5B and light shielding layers (black matrix) 23 having respective predetermined thickness are provided on one side of the glass substrate 1 and micro-color filters 22R, 22G, 22B are provided on the birefringence layers 5R, 5G, 5B (see FIG. 4 (a)). The optical element in the fifth embodiment may be used, for example, as a constituent member in a substrate for liquid crystal alignment.

Since the other construction is the same as the construction of the optical element 30 in the third embodiment, the constituent members other than the birefringence layers 5R, 5G, 5B are identified with the same reference characters as used in FIG. 4 (a), and the explanation thereof will be omitted. The birefringence layers 5R, 5G, 5B may be formed at respective predetermined places, for example, by photolithography.

The optical element 50 has the same technical effect as the optical element 30 in the third embodiment. Further, since the micro-color filters 22R, 22G, 22B are formed on the birefringence layers 5R, 5G, 5B, the following technical effects can also be attained.

Specifically, even when light is incident on the same medium, the refractive index of light varies depending upon wavelength of light. Therefore, retardation of red light, retardation of green light, and retardation of blue light can be controlled separately from each other by providing birefringence layers 5R, 5G, 5B having respective predetermined thicknesses so as to underlie the red micro-color filter 22R, the green micro-color filter 22G, and the blue micro-color filter 22B, respectively. Therefore, according to the optical element 50 in the fifth embodiment, as compared with the optical element 30 in the third embodiment or the optical element 40 in the fourth embodiment, the polarization state of light can be controlled more accurately.

An optical element having the same technical effect as the optical element 50 may also be produced by using, instead of the glass substrate 1, a light transparent base material comprising a glass thin film or a silicon oxide film provided directly on one side of a light transparent resin substrate. In this optical element, the birefringence layers 5R, 5G, 5B are provided directly on the silicon oxide film or thin glass film.

<Optical Element in Sixth Embodiment of Present Invention>

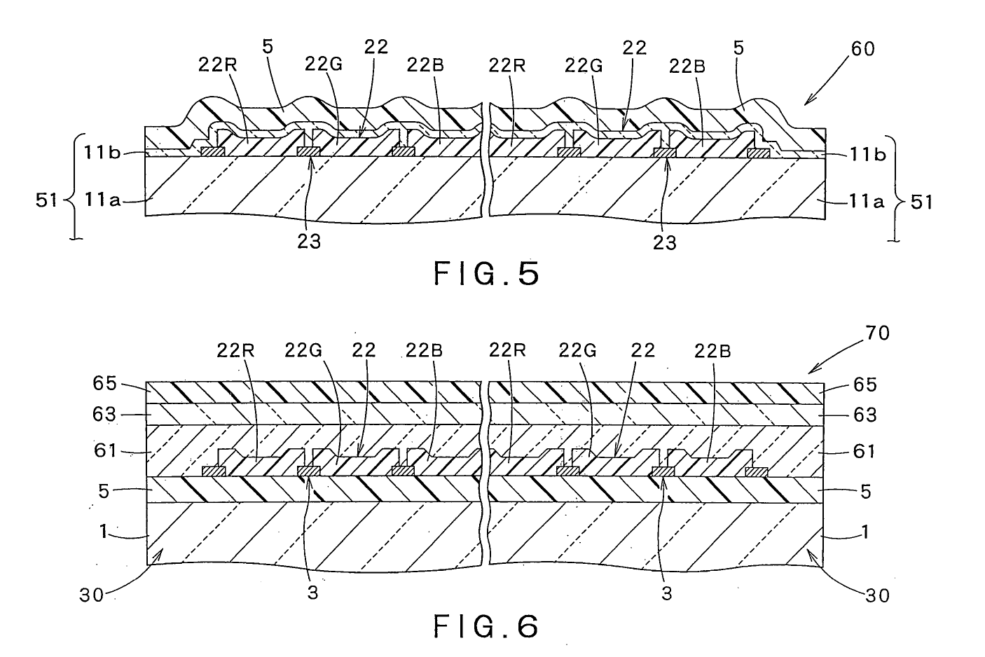

FIG. 5 is a schematic diagram showing still another embodiment of the basic sectional structure of the optical element according to the present invention. An optical element 60 includes a light transparent base material 51. The light transparent base material 51 comprises a resin substrate 11a as a light transparent substrate, a color filter 22 and a light shielding layer 23 provided on one side of the resin substrate 51a, and a silicon oxide film 11b provided to cover the color filter 22 and the light shielding layer 23. A birefringence layer 5 is provided directly on the silicon oxide film 11b in the light transparent base material 51. Among the constituent members shown in FIG. 5, constituent members common to FIG. 5 and FIG. 3 or FIG. 4 (a) are identified with the same reference characters as used in FIG. 3 or FIG. 4 (a), and the explanation thereof will be omitted.

The optical element 60 having the above structure has the same technical effect as the optical element 30 in the third embodiment. An optical element having the same technical effect may also be provided by using, instead of the resin substrate 11a, a light transparent glass substrate as the light transparent substrate.

<Optical Element in Other Embodiments of Present Invention (Variant)>

The provision of a light transparent base material having a surface formed of glass or silicon oxide and the birefringence layer (birefringence layer 5) provided directly on the surface formed of glass or silicon oxide suffices for the optical element according to the present invention. In addition to these constituent members, desired members, for example, a second birefringence layer having birefringence characteristics different from the birefringence layer 5, a retardation element, and an optical compensation element may be properly added.

Depending upon the material, formation method and the like, these optional constituent members may be provided as one layer constituting the light transparent base material and may be provided on the light transparent base material in its side remote from the birefringence layer 5 (i.e., a surface not having the surface formed of glass or silicon oxide). Further, the optional constituent members may also be provided on the birefringence layer or the color filter.

<Production Process of Optical Element>

The production process of the optical element according to the present invention is a production process of the optical element according to the present invention and includes a provision step, an alignment step, and a crosslinking step. Each step will be described in detail.

(1) Provision Step

In the provision step, a light transparent base material having a surface formed of glass or silicon oxide is provided. This light transparent base material may have the above-described single-layer structure or multilayer structure.

The layer construction to be selected in the light transparent base material may be properly selected according to applications of the optical element to be produced and the like. The light transparent base material may be produced, or alternatively may be a commercially available product.

(2) Alignment Step

In the alignment step, a coating composition containing a chiral agent and a polymerizable liquid crystal comprising rodlike molecules is coated directly on a film formed of glass or silicon oxide on the light transparent base material to form a coating, and the polymerizable liquid crystal in the coating is then aligned in a planar cholesteric phase.

The coating composition is prepared by using a chiral agent, a polyfunctional polymerizable liquid crystal, and an organic solvent as indispensable components and using a monofunctional polymerizable liquid crystal, a silane coupling agent, a photopolymerization initiator, a sensitizer and the like as optional components. For each component, only one type of the component may be used, or alternatively two or more types of the component may be used. The chiral agent, the polyfunctional polymerizable liquid crystal, the monofunctional polymerizable liquid crystal, and the silane coupling agent may be those as described in the optical element in the first embodiment of the present invention, and the explanation thereof will be omitted. The polymerizable liquid crystal contained in the coating composition is preferably a monomer.

The organic solvent may be any one so far as it can dissolve the polymerizable liquid crystal, and the type of the organic solvent can be properly selected. The optical polymerization initiator as the optional component may be radically polymerizable.

Examples of radically polymerizable photopolymerization initiators include (1) ketone compounds such as benzoin, benzophenone, and derivatives thereof, (2) xanthone and thioxanthone derivatives, (3) halogen-containing compounds such as chlorosulfonyl polynuclear aromatic compounds, chloromethyl polynuclear aromatic compounds, chloromethyl heterocyclic compounds, and chloromethylbenzophenones, (4) triazines, (5) fluorenones, (6) haloalkanes, (7) redox pairs of photoreducing coloring matters and reducing agents, (8) organosulfur compounds, and (9) peroxides. Among these radically polymerizable photopolymerization initiators, for example, Irgacure 184, Irgacure 369, Irgacure 651, and Irgacure 907 (all of which are tradenames of ketone photopolymerization initiators manufactured by Ciba Specialty Chemicals, K.K.), Darocur (tradename of a ketone photopolymerization initiator manufactured by Merck & Co. Inc.), and 2,2′-bis(o-chlorophenyl)-4,5,4′-tetraphenyl-1,2′-biimidazole (one of the halogen-containing compounds in the above item (3)) are preferred.

When the coating composition contains a photopolymerization initiator, the concentration thereof can be properly selected in such a concentration range that is not significantly detrimental to the alignment of the polymerizable liquid crystal. For example, the concentration of the photopolymerization initiator may be in the range of about 0.01 to 15% by weight, preferably in the range of about 0.5 to 10% by weight. When two or more photopolymerization initiators are used, a combination of photopolymerization initiators, which does not inhibit mutual spectrophotometric characteristics, is preferably selected. When the coating composition contains a sensitizer, the content thereof may be properly selected in such a content range that does not sacrifice the object of the present invention.

The concentration of the polymerizable liquid crystal in the coating composition varies depending, for example, upon coating methods, thickness of coating to be formed, and type of the organic solvent. Preferably, however, the concentration of the polymerizable liquid crystal is in the range of about 50 to 90% by weight.

As described above, the concentration of the chiral agent in the coating composition may be properly selected according to the center wavelength of the selective reflection from the birefringence layer. When the center wavelength is set in an ultraviolet region, the concentration of the chiral agent in the coating composition may be properly selected in the range of about 1 to 20% by weight, although it may vary depending upon the refractive index no, ne of the polymerizable liquid crystal.

The coating of the coating composition may be formed by coating the coating composition onto the film formed of glass or silicon oxide in the light transparent base material by spin coating or various printing methods (for example, die coating, bar coating, slide coating, or roll coating) or the like. When the water repellency or oil repellency of the surface (the surface formed of glass or silicon oxide), on which the coating is to be formed, is on a high level, preferably, the wettability of the surface is previously enhanced by pretreatment such as UV cleaning or plasma treatment.

In the alignment of the polymerizable liquid crystal in the coating formed as described above in a planar cholesteric phase, the coating should be heated to a temperature range from a temperature, at which the polymerizable liquid crystal in the coating is brought to a liquid crystal phase, or above to a temperature below a temperature at which the polymerizable liquid crystal is brought to an isotropic phase (a liquid phase) (this temperature being hereinafter referred to as “liquid crystal phase temperature”). When the polymerizable liquid crystal has been brought to a liquid crystal phase state, the polymerizable liquid crystal is aligned in a planar cholesteric phase through the action of alignment restriction force on the polymerizable liquid crystal on the surface formed of glass or silicon oxide and the action of the chiral agent.

(3) Crosslinking Step

In the crosslinking step, the polymerizable liquid crystal is three-dimensionally crosslinked in such a state that the polylmerizable liquid crystal in the coating is aligned in the above cholesteric phase, whereby the molecular arrangement of the polymerizable liquid crystal is fixed while holding the planar cholesteric phase structure. In this case, in order to prevent disturbance of the molecular alignment of the polymerizable liquid crystal, preferably, in the polymerization, the coating is exposed to light with wavelength to which the polymerizable liquid crystal, the photopolymerization initiator, or the sensitizer is sensitive while heating the coating in an inert gas atmosphere to the liquid crystal phase temperature. Alternatively, a method may be preferably adopted which comprises exposing the coating in an air atmosphere to light with wavelength to which the polymerizable liquid crystal, the photopolymerization initiator, or the sensitizer is sensitive while heating the coating to the liquid crystal phase temperature to allow a crosslinking reaction to partially proceed, then cooling the coating in the air atmosphere to a temperature at which the polymerizable liquid crystal is brought to a crystal phase, and, in this state, exposing the coating to light with the above wavelength to which the polymerizable liquid crystal, the photopolymerization initiator, or the sensitizer is sensitive to substantially complete the crosslinking reaction. The “temperature at which the polymerizable liquid crystal is brought to a crystal phase” refers to a temperature at which, in the coating before crosslinking, the polymerizable liquid crystal is brought to a crystal phase state.

The wavelength to which the polymerizable liquid crystal, the photopolymerization initiator, or the sensitizer is sensitive varies depending upon the type of the polymerizable liquid crystal, the photopolymerization initiator, or the sensitizer. Therefore, the wavelength of light to be applied is properly selected depending upon the type of the polymerizable liquid crystal, the photopolymerization initiator, or the sensitizer contained in the coating. The light to be applied to the coating is not necessary monochromatic light and may be light in a wavelength region containing light with wavelength to which the polymerizable liquid crystal, the photopolymerization initiator, or the sensitizer is sensitive.

The crosslinking step following the alignment step can provide an optical element that comprises: a birefringence layer comprising a chiral agent and a polymerizable liquid crystal comprised of rodlike molecules, the polymerizable liquid crystal having a molecular arrangement which has been fixed by crosslinking while holding a planar cholesteric phase structure; and a light transparent base material for supporting the birefringence layer, a substrate layer underlying the birefringence layer being formed of glass or silicon oxide.

<Substrate for Liquid Crystal Alignment>

FIG. 6 is a schematic diagram showing one embodiment of the basic sectional structure of the substrate for liquid crystal alignment according to the present invention. A substrate 70 for liquid crystal alignment has the following structure. A flattening film 61 is provided on the color filter 22 and the light shielding layer 23 in the optical element 30 in the third embodiment shown in FIG. 4 (a) to cover the color filter 22 and the light shielding layer 23, and a transparent electrode pattern 63 and an aligning film 65 are stacked in that order on the flattening film 61. Among the constituent members in the substrate 70 for liquid crystal alignment, constituent members common to FIG. 6 and FIG. 4 (a) are identified with the same reference characters as used in FIG. 4 (a), and the description thereof will be omitted.

The flattening film 61 is a layer that provides a flat surface for the transparent electrode pattern 63 formation and, at the same time, functions to improve chemical resistance, heat resistance, ITO (indium tin oxide) resistance and the like of the substrate 70 for liquid crystal alignment. This flattening film 61 may be formed of various photocurable resins or heat-curable resins, or two-component curable resins, for example, acrylic resins, epoxy resins, and polyimide resins. The flattening film 61 may be formed by spin coating, printing, photolithography or the like depending upon the material. The thickness of the flattening film 61 may be properly selected in the range of about 0.3 to 5.0 μm, preferably about 0.5 to 3.0 μm.

In a liquid crystal panel for display using the substrate 70 for liquid crystal alignment, voltage for controlling the alignment of the liquid crystal is applied to the transparent electrode pattern 63. The transparent electrode pattern 63 is formed of, for example, a transparent electrode material such as ITO and is used as an electrode (common electrode) common to all the pixels in the liquid crystal panel for display.

When a liquid crystal panel for display has been prepared using the substrate 70 for liquid crystal alignment, the aligning film 65 is a vertically aligning film for homeotropically aligning a liquid crystal in a liquid crystal cell or a horizontally aligning film for horizontally aligning the liquid crystal. The aligning film is formed of, for example, a resin material. If necessary, the surface of the aligning film is subjected to rubbing treatment or photoalignment treatment. Whether the aligning film 65 to be used is the vertically aligning film or the horizontally aligning film may be properly determined depending, e.g., upon an operation mode of the liquid crystal panel for display to be prepared using the substrate 70 for liquid crystal alignment.

The substrate 70 for liquid crystal alignment having the above structure can be used, for example, as a substrate on the display face side of the liquid crystal panel for display in a liquid crystal display device of a VA (vertically alignment) system, a TN (twisted nematic) system or the like. Since the substrate 70 for liquid crystal alignment has a birefringence layer 5, visual angle characteristics in the direction of an azimuth of 45 degrees or 135 degrees to the polarization axis of an analyzer (not shown) constituting the liquid crystal panel for display can be improved by providing a retardation plate or a retardation film, which is optically monoaxial and has an optical axis within the plane, that is, the so-called “+A plate”, for example, on the outer surface of the glass substrate 1 (outer surface in the liquid crystal panel for display).

Further, since the birefringence layer 5 is provided directly on the glass substrate 1, the number of interfaces is reduced by one as compared with the case where an optical compensation film having the same function as the birefringence layer 5 is applied onto the glass substrate 1 with the aid of a pressure-sensitive adhesive, and, as a result, the quantity of light reflected at the interfaces is also reduced. Therefore, in the liquid crystal panel for display using the substrate 70 for liquid crystal alignment, a lowering in contrast for display images is suppressed. Further, in the birefringence layer 5 in which the molecular arrangement of the polymerizable liquid crystal has been fixed by crosslinking, a change in volume derived from moisture absorption does not substantially take place. Therefore, even when an attempt to increase the size of the substrate for liquid crystal alignment (an increase in size of a liquid crystal panel for display) is made, a change in birefringence characteristics attributable to the volume change of the birefringence layer 5 is suppressed, resulting in suppressed distortion of displayed images.

For the above reasons, when the substrate 70 for liquid crystal alignment is used, a liquid crystal display device having excellent display characteristics can easily be provided. In the substrate 70 for liquid crystal alignment, the optical element 30 in the third embodiment is used as a constituent member, and this optical element can be produced with high productivity. Therefore, the use of the substrate 70 for liquid crystal alignment can realize the production of a liquid crystal display device having excellent display characteristics with high productivity.

The provision of the flattening film 61 may be omitted. Further, instead of the optical element 30, for example, the optical element 40 in the fourth embodiment, the optical element 50 in the fifth embodiment, or the optical element 60 in the sixth embodiment may be used as the constituent member to provide the substrate for liquid crystal alignment.

<Substrate for Liquid Crystal Alignment in Other Embodiments (Variant)>

The construction of the substrate for liquid crystal alignment according to the present invention is not limited, so far as it comprises at least a light transparent base material and an aligning film provided on one side of the light transparent base material, the above-described birefringence layer 5 is provided between the light transparent base material and the aligning film or on the surface of the light transparent base material in its side remote from the above one side, and a layer underlying the birefringence layer 5 is formed of glass or silicon oxide.

For example, in the substrate for liquid crystal alignment used as a substrate on the display surface side of a liquid crystal panel for display of an IPS (in-plane-switching) system, the provision of the transparent electrode pattern 63 shown in FIG. 6 is unnecessary. Therefore, when the flattening layer 61 is formed, the aligning film 65 may be formed on the flattening layer 61. When the flattening layer 61 is omitted, the aligning film 65 may be formed so as to cover the color filter 22 and the light shielding layer 23.

Further, the construction of the light transparent base material may be such that a second birefringence layer (for example, A plate) formed of a resin or polymerizable liquid crystal composition having birefringence characteristics different from the birefringence layer 5 may be provided on one side of the light transparent substrate (a light transparent glass substrate or resin substrate) and a glass thin film or silicon oxide film is formed directly on the second birefringence layer. In this case, the birefringence layer 5 is formed directly on the glass thin film or silicon oxide film provided directly on the second birefringence layer. The aligning film may be provided above the birefringence layer 5 through a light absorption-type color filter, a light shielding layer (black matrix) or the like, or alternatively may be provided on the light transparent base material in its side remote from the second birefringence layer through a light absorption-type color filter, a light shielding layer (black matrix) or the like. The substrate for liquid crystal alignment having the above construction may be used, for example, as the substrate on the display surface side of a liquid crystal panel for display in a transmission liquid crystal display device.

The construction of the light transparent base material may also be such that a linearly polarizing element and a quarter-wavelength resin plate are stacked in that order on one side of a light transparent glass substrate or resin substrate and a glass thin film or silicon oxide film is provided directly thereon. In this case, the birefringence layer 5 is formed directly on the glass thin film or silicon oxide film provided on the quarter-wavelength plate. The provision of the color filter and the light shielding layer may be omitted. The aligning film may be provided on the light transparent base material in its side remote from the linear polarizer through various layers. The substrate for liquid crystal alignment having the above construction may be used, for example, as the substrate on the backside of a liquid crystal panel for display in a transmission liquid crystal display device.

A substrate for liquid crystal alignment used as a substrate on the display surface side of a liquid crystal panel for display in a reflection liquid crystal display device may be prepared by stacking the birefringence layer 5, the quarter-wavelength plate, and the linearly polarizing element in that order on one side of the light transparent base material. In this case, a color filter and a light shielding layer (black matrix) are provided on the light transparent base material in its side remote from the birefringence layer 5. The aligning film is provided to cover the color filter and the light shielding layer either directly or through the transparent electrode pattern. Likewise, a substrate for liquid crystal alignment used as a substrate on the display surface side of a liquid crystal panel for display in a reflective liquid crystal display device may be prepared by forming the birefringence layer 5 on one side of a light transparent base material and stacking a quarter-wavelength plate and a linearly polarizing element in that order on the light transparent base material in its side remote from the birefringence layer 5. In this case, a color filter and a light shielding layer (black matrix) are provided on the birefringence layer 5. The aligning film is provided to cover the color filter and the light shielding layer either directly or through the transparent electrode pattern. In a reflection liquid crystal display device provided with any one of these substrates for liquid crystal alignment, the polarized state of light incident on the reflector can be made close to a true circularly polarized state, and, thus, display having excellent contrast can be realized.

<Liquid Crystal Display Device>

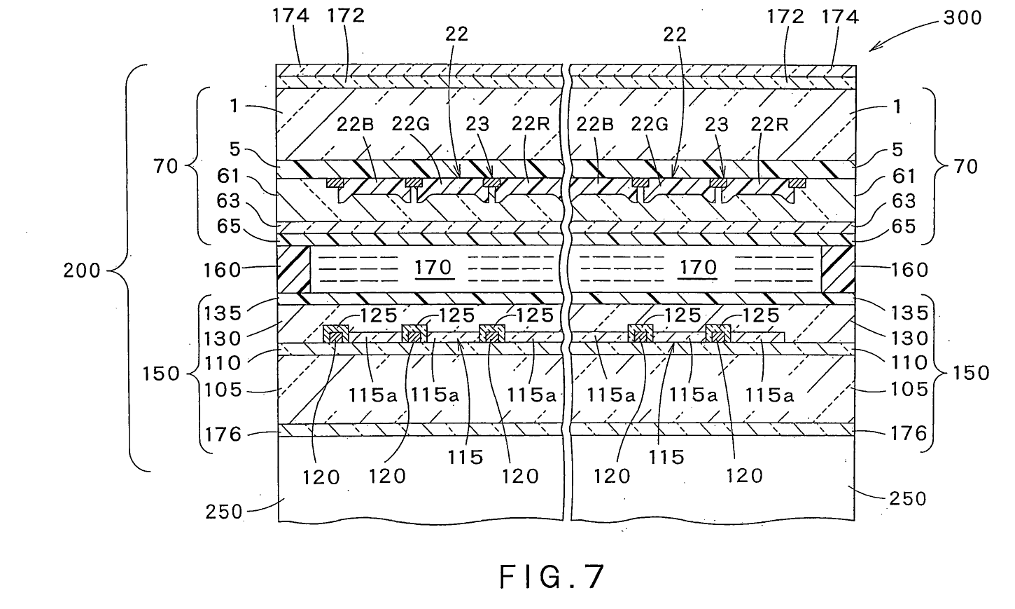

FIG. 7 is a schematic partial cross-sectional view showing one embodiment of the liquid crystal display device according to the present invention. A liquid crystal display device 300 is a transmission liquid crystal display device of an active matrix drive system, comprising a liquid crystal panel 200 for display, a backlight part 250 installed behind the liquid crystal panel 200 for display, and an external circuit (not shown).

The liquid crystal panel 200 for display comprises the substrate 70 for liquid crystal alignment, shown in FIG. 6, as a display face-side substrate (a first substrate for liquid crystal alignment) and a substrate 150 for liquid crystal alignment as a substrate on back side (a second substrate for liquid crystal alignment).

The substrate 150 for liquid crystal alignment has a structure comprising: the light transparent substrate 105; and, provided on the light transparent substrate 105, scanning lines, an interlayer insulating film 110, a transparent electrode pattern 115 comprising a large number of pixel electrodes 115a arranged in a matrix form, a signal line 120, a protective film (a passivation film) 125, a switching circuit part, a flattening film 130, and an aligning film 135.

Scanning lines (not shown) are disposed so that each one scanning line corresponds to one line of the large number of pixel electrodes 115a disposed in a matrix form and is extended in the longitudinal direction of the line. Each scanning line may be formed of, for example, a metal such as tantalum (Ta) or titanium (Ti). These scanning lines are covered by the interlayer insulating film 110.

The interlayer insulating film 110 is formed of, for example, an electrically insulating material such as silicon oxide to electrically separate the scanning line from the signal line 120 and, at the same time, to electrically separate the pixel electrode 115a from the scanning line.

Each pixel electrode 115a is formed of, for example, a transparent electrode material such as indium tin oxide (ITO) and is provided so as to correspond to one pixel in the liquid crystal panel 200 for display in one-by-one relationship. The form on plane vision of the individual pixel electrodes 115a may be a polygon, for example, a quadrangle or a hexagon formed by cutting away one corner part of a quadrangle to a rectangular form.

The signal lines 120 are disposed so that one signal line corresponding to one column of the large number of pixel electrodes 115a disposed in a matrix form, and are extended in the longitudinal direction of the column. Each signal line 120 may be formed of, for example, a metal such as tantalum (Ta) or titanium (Ti). These signal lines 120 are covered by the protective film 125.

The protective film 125 is formed of, for example, silicon nitride. The protective film 125 functions to protect the members underlying the protective film 125 and to electrically separate the signal line 120 from the pixel electrode 115a.

Each switching circuit part (not shown in FIG. 7) is disposed so as to correspond to one pixel electrode 115a in one-by-one relationship to electrically connect the pixel electrode 115a, to which the switching circuit part corresponds, to the scanning line and the signal line 120. Individual switching circuit parts receive the supply of a signal from the respective corresponding scanning lines to control the continuity between the signal line 120 and the pixel electrode 115a. Each switching circuit part may be formed of, for example, one active element. The active element may be, for example, a three-terminal element such as a thin-film transistor or a two-terminal element such as an MIM (metal insulator metal) diode.

The flattening film 130 is provided so as to cover the protective film 120 and the transparent electrode pattern 115 to provide a flat face for forming an aligning film 135. This flattening film 130 may be formed, for example, in the same manner as in the flattening film 61 in the substrate 70 for liquid crystal alignment shown in FIG. 6.

The aligning film 135 is a vertically aligning film for homeotropically aligning the liquid crystal or a horizontally aligning film for horizontally aligning a liquid crystal in a liquid crystal cell in a liquid crystal display panel 200. Whether the aligning film 135 to be used is the vertically aligning film or the horizontally aligning film may be properly determined depending, e.g., upon an operation mode of the liquid crystal display device 300.

The substrate 150 for liquid crystal alignment having the above structure and the substrate 70 for liquid crystal alignment are applied to each other with the aid of a sealing material (thermosetting resin) 160 while providing a gap therebetween so that the aligning film 65 in the substrate 70 for liquid crystal alignment faces the aligning film 135 in the substrate 150 for liquid crystal alignment. The gap (cell gap) between the substrates 70, 150 for liquid crystal alignment is kept constant, for example, by a spacer such as a spherical spacer or a columnar spacer (not shown), and the gap therebetween is filled with a liquid crystal material to form a liquid crystal layer 170.

A retardation film, which is optically monoaxial and has an in-plane optical axis (the so-called “+A plate”) 172, is applied to the outer surface of the substrate 70 for liquid crystal alignment, and an analyzer 174 is applied thereonto. On the other hand, a polarizer 176 is applied to the outer surface of the substrate 150 for liquid crystal alignment. The analyzer 174 and the polarizer 176 may be disposed in a crossed Nicol relationship or a parallel Nicol relationship. The backlight part 250 is disposed behind the polarizer 176.

The liquid crystal display device 300 having the above construction may be used, for example, as a transmission liquid crystal display device of a VA (vertically alignment) system or a TN (twisted nematic) system. In the case of the liquid crystal display device of a VA system, a vertically aligning film is used as the aligning films 65, 135. On the other hand, in the case of the liquid crystal display device of a TN system, a horizontally aligning film is used as the aligning films 65,135. In the liquid crystal display device 300, the substrate 70 for liquid crystal alignment is used as the first substrate for liquid crystal alignment, and the retardation film 172 is applied onto the outer surface of the substrate 70 for liquid crystal alignment. Thus, since the substrate for liquid crystal alignment according to the present invention is used in the liquid crystal display device 300, the liquid crystal display device 300 has excellent display characteristics and can be produced with high productivity, that is, at a low cost.

Further, since the birefringence layer 5 has relatively high heat resistance, the liquid crystal display device 300 can be of course used as an indoor liquid crystal display device and further can be used as an on-vehicle liquid crystal display device which is exposed to a relatively high temperature environment.

The liquid crystal display device according to the present invention may be such that a liquid crystal panel for display comprising a first substrate for liquid crystal alignment located on display surface side and a second substrate for liquid crystal alignment located on back side is provided and, in addition, the substrate for liquid crystal alignment according to the present invention is used on at least one of the first substrate for liquid crystal alignment and the second substrate for liquid crystal alignment.

The operational mode of the liquid crystal display device may be properly selected from IPS system, VA system, TN system and the like, and the display system and the drive system may also be properly selected. When the substrate for liquid crystal alignment according to the present invention is provided on at least one of the first substrate for liquid crystal alignment and the second substrate for liquid crystal alignment, the structure of the liquid crystal panel for display may be properly selected according to the operational mode of the liquid crystal display device to be provided, the display system, the drive system and the like.

### EXAMPLES

The following Examples further illustrate but do not limit the present invention.

### Example 1

### Preparation of Optical Element 1

(1) Step of Provision and Step of Alignment

A 0.7 mm-thick alkali-free glass substrate (NA-35 manufactured by NH TECHNO GLASS CORP.) was first provided as a light transparent base material. 22 parts by weight of a polyfunctional polymerizable liquid crystal represented by formula (III), 1.8 parts by weight of a polymerizable chiral agent, and 1.3 parts by weight of a photopolymerization initiator were dissolved in 74.9 parts by weight of chlorobenzene to prepare a coating composition for birefringence layer formation. A compound represented by the following formula, which is one of the compounds represented by formula (i), was used as the polymerizable chiral agent: 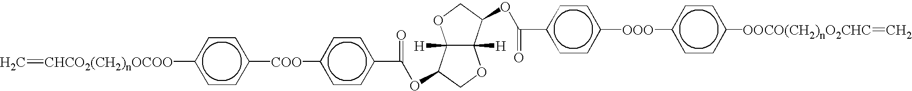
wherein n is an integer of 1 to 6. Irgacure 907 (Irg 907 manufactured by Ciba Specialty Chemicals, K.K.) was used as a photopolymerization initiator.

Next, the coating composition for birefringence layer formation was spin coated onto the glass substrate to form a coating which was then heated at 80° C. for 3 min. The state of the coating was changed from a milky state to a transparent state with the elapse of heating time, indicating that the phase of the polymerizable liquid crystal in the coating was transited from a crystal phase to a liquid crystal phase upon heating.

(2) Step of Crosslinking

While heating the coating subjected to phase transition of the polymerizable liquid crystal at 80° C., ultraviolet light was applied to the coating in a nitrogen gas atmosphere to three-dimensionally crosslink the polymerizable liquid crystal in the coating. At that time, the ultraviolet light was applied with an ultraviolet light irradiation apparatus provided with an ultrahigh pressure mercury lamp as a light source under conditions of irradiation intensity 20 mW/cm² and irradiation time 5 sec.

At a point of time when steps up to the crosslinking step had been completed, a birefringence layer comprising the polymerizable liquid crystal represented by formula (III) and the chiral agent represented by the above formula was formed. Thus, a contemplated optical element 1 was prepared.

The thickness of the birefringence layer in this optical element 1 was measured with a tracer type bench-top surface profiler and was found to be about 1.5 μm.

(3) Evaluation of Optical Element 1

Retardation in the thickness-wise direction of the optical element 1 was measured with an apparatus KOBRA-21 manufactured by Oji Scientific Instruments at a measurement wavelength of 550 nm and was found to be 1 nm. The thickness-wise direction in the case where the optical element was disposed horizontally was used as a reference, and the optical element was flapped in any direction from this direction. This caused a change in retardation. For example, when the optical element 1 was inclined by 45 degrees from the direction of the thickness, the retardation was about 27 nm. When the results of measurement and conditions for the birefringence layer formation are taken into consideration, it is considered that, in the birefringence layer in the optical element 1, the polymerizable liquid crystal is aligned in a planar cholesteric phase.

Further, even after heating of the optical element 1 to 200° C., the birefringence layer maintained a transparent state without causing phase transition. From this fact, the birefringence layer is judged to have a structure that the molecular arrangement of the polymerizable liquid crystal has been fixed by crosslinking while holding a planar cholesteric phase structure. The haze value of the birefringence layer in the optical element 1 was measured with an apparatus NDH 2000 (manufactured by Nippon Denshoku Co., Ltd.) and was found to be 1%.

### Example 2

### Preparation of Optical Element 2

(1) Step of Provision, Step of Alignment, and Step of Crosslinking

The step of provision, the step of alignment, and the step of crosslinking were successively carried out in the same manner as in Example 1, except that, in the preparation of the coating composition for birefringence layer formation, 0.05 part by weight of an amine silane coupling agent (TSL 8331 manufactured by Toshiba Silicone Co., Ltd.) was also used, and the amount of chlorobenzene used was changed to 74.85 parts by weight. Thus, an optical element 2 was prepared. The thickness of the birefringence layer in the optical element 2 was measured and was found to be about 1.5 μm.

(2) Evaluation of Optical Element 2

Retardation in the thickness-wise direction of the optical element 2 was measured in the same manner as in Example 1 and was found to be 0 nm. The thickness-wise direction in the case where the optical element was disposed horizontally was used as a reference, and the optical element was flapped in any direction from this direction. This caused a change in retardation. When the results of measurement and conditions for the birefringence layer formation are taken into consideration, it is considered that, in the birefringence layer in the optical element 2, the polymerizable liquid crystal is aligned in a planar cholesteric phase.

Further, even after heating of the optical element 2 to 200° C., the birefringence layer maintained a transparent state without causing phase transition. From this fact, the birefringence layer is judged to have a structure that the molecular arrangement of the polymerizable liquid crystal has been fixed by crosslinking while holding a planar cholesteric phase structure. The haze value of the birefringence layer in the optical element 2 was measured in the same manner as in Example 1 and was found to be not more than 0.1%.

1. An optical element comprising: a birefringence layer comprising a chiral agent and a polymerizable liquid crystal comprised of rodlike molecules; and a light transparent base material for supporting the birefringence layer,
said polymerizable liquid crystal having a molecular arrangement which has been fixed by crosslinking while holding a planar cholesteric phase structure,
a substrate layer underlying said birefringence layer being formed of glass or silicon oxide.

2. The optical element according to claim 1, wherein said light transparent base material is a glass substrate and said birefringence layer is provided directly on one side of said glass substrate.

3. The optical element according to claim 1, wherein said light transparent base material comprises a resin substrate and a glass thin film or a silicon oxide film provided on one side of the resin substrate and said birefringence layer is provided directly on said glass thin film or silicon oxide film.

4. The optical element according to claim 1, wherein said light transparent base material comprises a light transparent substrate, a light absorption-type color filter provided on said light transparent substrate, a glass thin film or a silicon oxide film provided to cover the light absorption-type color filter and said birefringence layer is provided directly on the glass thin film or silicon oxide film.

5. The optical element according to claim 1, wherein said birefringence layer further comprises a silane coupling agent.

6. A process for producing an optical element according to claim 1, said process comprising:
providing a light transparent base material provided with a film formed of glass or silicon oxide;
coating a coating composition comprising a chiral agent and a polymerizable liquid crystal of rodlike molecules onto a said film formed of glass or silicon oxide,
aligning said polymerizable liquid crystal in the coating to a planar cholesteric phase; and
crosslinking said polymerizable liquid crystal in such a state that the alignment in the planar cholesteric phase is held, thereby fixing the molecular arrangement of said polymerizable liquid crystal.

7. The process according to claim 6, wherein said coating composition further comprises a silane coupling agent.

8. A substrate for liquid crystal alignment, comprising at least a light transparent base material and an aligning film provided on one side of said light transparent base material, wherein
a birefringence layer is provided between said light transparent base material and said aligning film or on the base material in its surface remote from said aligning film,
said birefringence layer comprises a chiral agent and a polymerizable liquid crystal comprised of rodlike molecules, and the molecular arrangement of the polymerizable liquid crystal has been fixed by crosslinking while holding a planar cholesteric phase structure, and
a substrate layer underlying said birefringence layer is formed of glass or silicon oxide.

9. The substrate for liquid crystal alignment according to claim 8, wherein
said light transparent base material comprises a glass substrate,
said birefringence layer is provided directly on one side of said glass substrate,
a light absorption-type color filter is provided on said birefringence layer, and
said aligning film is provided to cover said light absorption-type color filter.

10. The substrate for liquid crystal alignment according to claim 8, wherein
said light transparent base material comprises a resin substrate and a glass thin film or a silicon oxide film provided on one side of the resin substrate and said birefringence layer is provided directly on said glass thin film or silicon oxide film,
a light absorption-type color filter is provided on said birefringence layer, and
said aligning film is provided to cover said light absorption-type color filter.

11. The substrate for liquid crystal alignment according to claim 8, wherein said light transparent base material comprises a light transparent substrate, a light absorption-type color filter provided on said light transparent substrate, a glass thin film or a silicon oxide film provided to cover the light absorption-type color filter,
said birefringence layer is provided directly on the glass thin film or silicon oxide film, and
said aligning film is provided to cover said birefringence layer.

12. A liquid crystal display device comprising a liquid crystal panel for display, said liquid crystal panel comprising: a first substrate for liquid crystal alignment located on its display surface side; and a second substrate for liquid crystal alignment located on its backside, wherein
said first substrate for liquid crystal alignment and/or said second substrate for liquid crystal alignment are the substrate for liquid crystal alignment according to claim 8.

13. A birefringent material comprising a chiral agent, a polymerizable liquid crystal comprised of rodlike molecules, and a silane coupling agent, wherein the molecular arrangement of said polymerizable liquid crystal has been fixed by crosslinking while holding a planar cholesteric phase structure.
